(19) United States
(12) Patent Application Publication
(10) Pub. No.: US 2008/0004879 A1
(43) Pub. Date: Jan. 3, 2008

(54) Method for assessing learner's pronunciation through voice and image

(76) Inventor: Wen-Chen Huang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/476,716

(22) Filed: Jun. 29, 2006

(51) Int. Cl. G10L 21/00

(52) U.S. Cl. 704/270

(57) ABSTRACT

The present invention relates to a method for assessing a learner's pronunciation through voices and images, in which variation of the teacher's and the learner's lips are compared in a visual manner. Accordingly, incorrect pronunciation can be pointed out and recorded for assessment and rectification.

### BACKGROUND OF THE INVENTION

1. Field of the Invention

The present invention relates to a method for assessing a learner's pronunciation through voices and images, and particularly to an assessment method using a visual manner to compare variation of the teacher's and the learner's lips, so that incorrect pronunciation can be pointed out and thus rectified.

2. Related Prior Art

Learning with digital devices is more and more popular now. For example, computer aided design (CAD) is very convenient for users' operation and learning through the figure interface. Currently, most English learning softwares provide users to practice listening, speaking, reading and writing. However, these softwares can provide only video or natural speech for the users to practice speaking, but can not adjudge the learner's pronunciation correct or incorrect. In addition, it's difficult for the deaf people to practice English via such ways.

So far, most of the e-learning programs are not synchronous and play only tutoring video via multimedia servers. There're many demerits for learning English by these methods, for example, the learner can practice speech by following the teacher but can not clearly find his incorrect pronunciation due to incorrect lip variation, and the deaf people can not practice English by listening.

Therefore, it's desired to develop a proper method or system to overcome the above problems.

### SUMMARY OF THE INVENTION

The present invention provides a novel method for assessing the learner's pronunciation by comparing the teacher's and the learner's lip variations and acoustic signals, so that the learner can find incorrect pronunciation and thus rectify it.

In a visual manner, the present invention detects and compares the teacher's and the learner's lip variations, whereby assessment of pronunciation can be achieved accordingly.

The present invention can be applied in e-learning and school education, and hence save personnel cost. For the learners, incorrect lip variations can be shown on visual images when practice speech, it will be more efficient to rectify pronunciation. Moreover, visual images can facilitate the deaf people to practice English.

In the present invention, that pronunciation is correct or not can be judged by comparing the lips on a certain syllable. The present invention primarily performs functions as follows: (a) recording the teacher's lip images and voices, and extracting key frames for comparing with the learner's; (b) recording the learner's lip images with a WebCam and determining lip contours from these images so as to compare with the teacher's lip images; (c) detecting lip contours with “connected component analysis” and searching the features; (d) increasing or updating the recorded speeches by the teacher and searching lip features of the images and voices; (e) assessing the learner's pronunciation with DTW technique based on both voices and lip images.

In the present invention, the method or system includes:

(1) adding a new word or sentence by a teacher via an interface, capturing the teacher's lip with a WebCam, and storing lip images and corresponding acoustic signals in a database;

(2) selecting and speaking a word or a sentence from the database;

(3) capturing the learner's lip images with a WebCam;

(4) automatically finding a lip zone by distinguishing colors of the learner's face with color space conversion and then dividing the face into several pixels, eliminating spots, computing the image with an algorithm, and defining a range of the learner's face so as to searching a boundary of the lip;

(5) assessing the learner's pronunciation by comparing the captured lip images and voices with those built in the database.

In the above method or system, the learner's speech can be captured with the WebCam and then compared with the teacher's speech information stored in the database. The teacher can add a new word or sentence, or update the word or sentence existed in the database. The database includes paths for saving all recorded words and sentences and lip images thereof, and can be searched by the users. The assessment model may include a threshold for judging correctness of the learner's pronunciation through a DTW technique and several grades for sorting the learner's level.

### BRIEF DESCRIPTION OF THE DRAWINGS

FIG. 1 shows the process of the present invention.

FIG. 2 shows the screen for adding a new sentence.

FIG. 3 shows the screen for selecting a sentence to practice.

FIG. 4 shows the screen including the WebCam.

FIG. 5 shows the process for detecting the lip.

FIG. 6 shows the lip zone formed by moving the left and right boundaries inward one eighth.

FIG. 7 shows the lip image divided with the RGB color system.

FIG. 8 shows the lip image divided with the HSV color system.

FIG. 9 shows the lip image processed with the median filter.

FIG. 10 shows the four or eight neighboring pixels of one pixel (P) processed with the “connected component analysis”.

FIG. 11 shows the original image before “connected component analysis”.

FIG. 12 shows the image numbered with “connected component analysis”.

FIG. 13 illustrates how to detect the lip.

FIG. 14 illustrates information of the lip.

FIG. 15 shows the teacher's and the learner's sequential lip images processed with DWT.

FIG. 16 shows corresponding positions of the teacher's and the learner's speech information matched with DTW.

FIG. 17 shows the teacher's and the learner's lip images matched with DTW.

FIG. 18 shows the DTW matrix.

FIG. 19 shows the process for treating the acoustic signals.

FIG. 20 shows the sonic waves after endpoints detection.

### DETAILED DESCRIPTION OF THE PREFERRED EMBODIMENTS

To clearly describe techniques, features and effects of the present invention, preferred embodiments are illustrated with drawings.

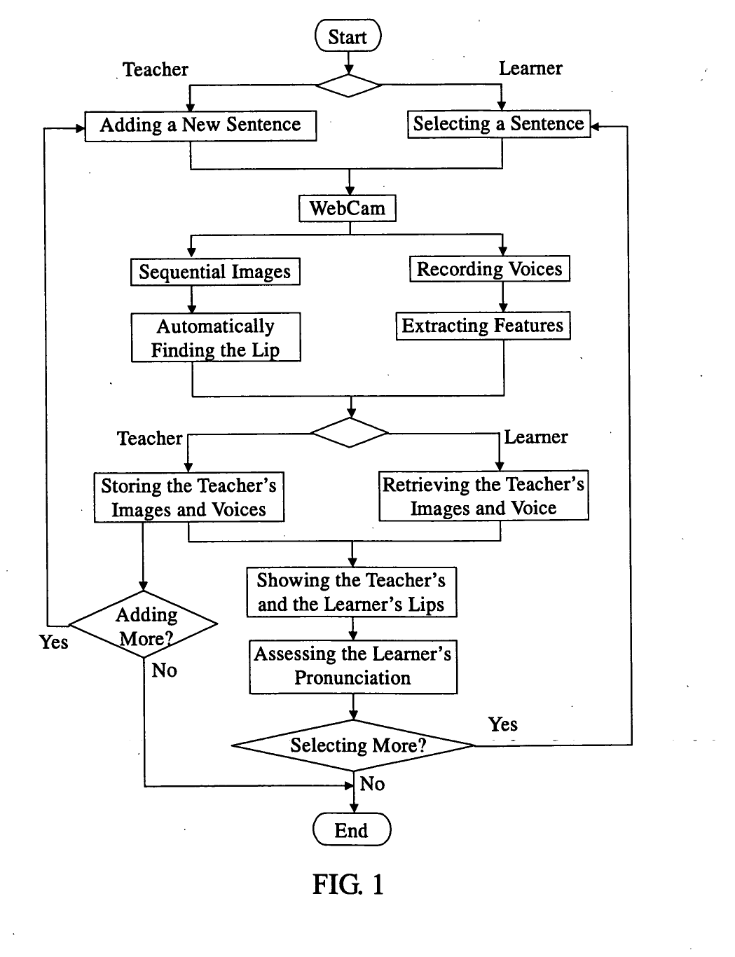

In the present invention, a method for assessing a learner's pronunciation through voices and images applies a visual manner to detect variations of the learner's lip during pronunciation, which are then compared with those of a teacher so as to show possible incorrectness. Further, the learner's speech can be recorded as a basis of assessment. FIG. 1 shows a process of the present invention and includes steps as follows.

(a) Adding New Words or Sentences (S1)

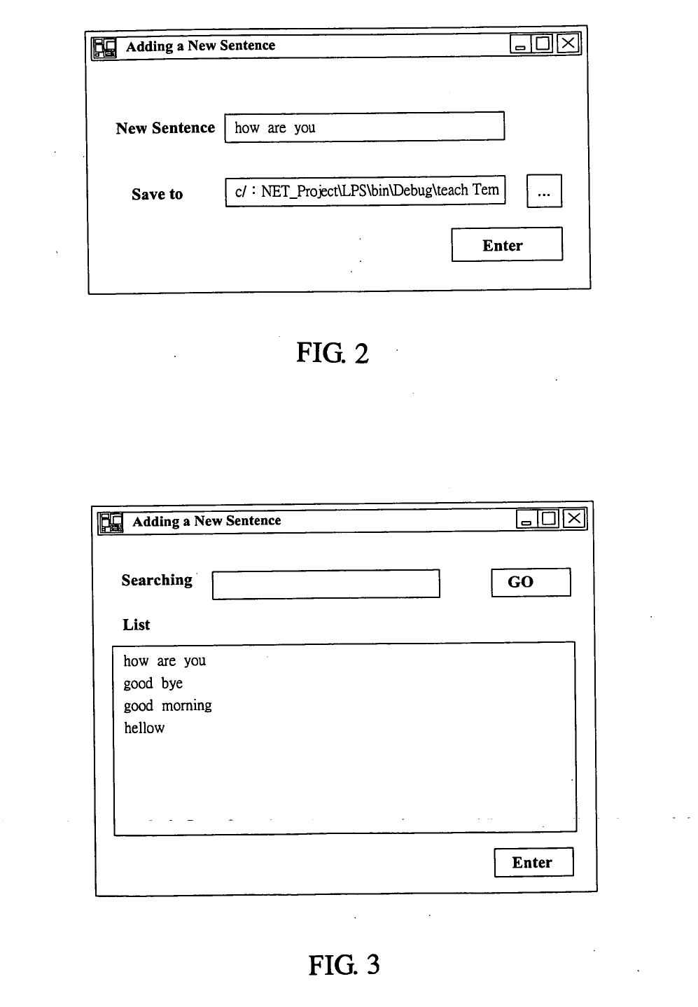

A teacher can input words or sentences through this interface, and assign a proper site for storing them. These words and sentences will be stored in a database according to the instruction and can be conveniently selected later as shown in FIG. 2.

(b) Selecting a Word or Sentence (S2)

As shown in FIG. 3, the learner can select or search a word or sentence for practicing from a selection window wherein a sub-window shows “all words/sentences” for listing all words and sentences in the database in alphabetical order.

(c) Capturing with a WebCam (S3)

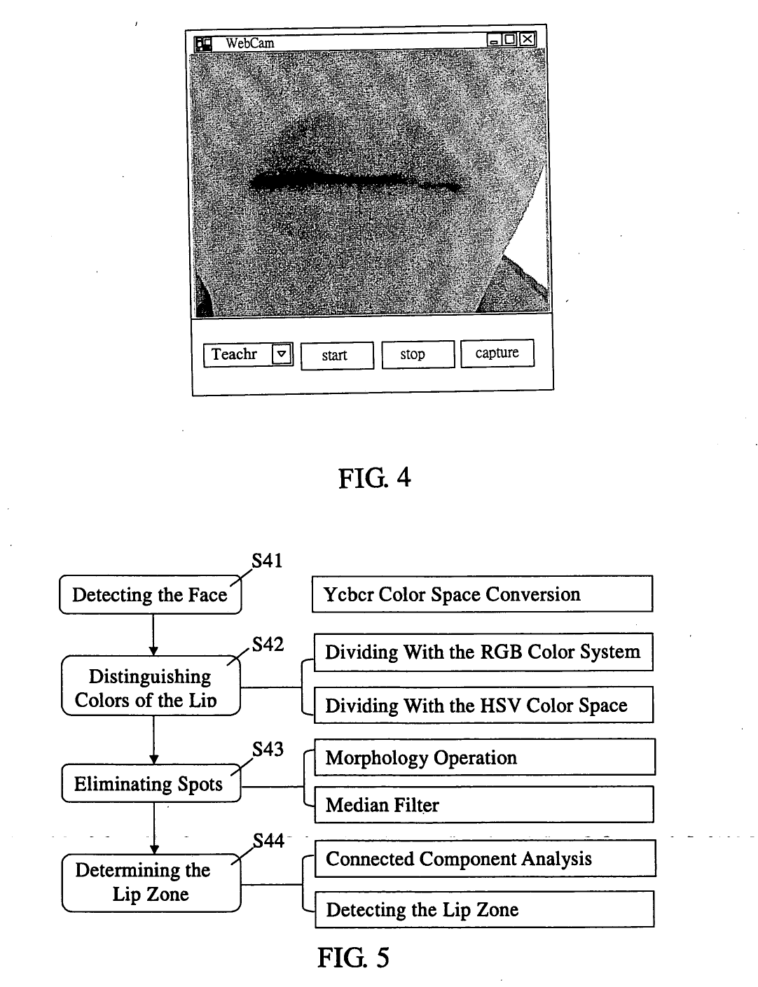

The learner (or teacher) focuses his lip on the WebCam and then presses a button to capture lip images during pronouncing, as shown in FIG. 4.

(d) Automatically finding a lip Zone (S4)

In the present invention, information of the lip is acquired by automatically detecting the lip and used to oral pronunciation practice. Color space YCbCr is first applied to divide the face into several pixels, and then RGB color space is applied to detect the lip.

FIG. 5 shows a process for automatically detecting the lip.

First, to precisely and fast finding the lip zone, the face is detected with the YCbCr color space, and then divided with a RGB and HSV system within the face range so as to determine a possible lip zone. To clearly distinguish the lip zone, after dividing with color, morphology operation and median filter are applied to eliminate spots. Then the binary image is treated with “connected component analysis” to give the same number to pixels of the same color, wherein the pixels of the most numbers form the lip zone.

### 1. Detecting the Face (S41)

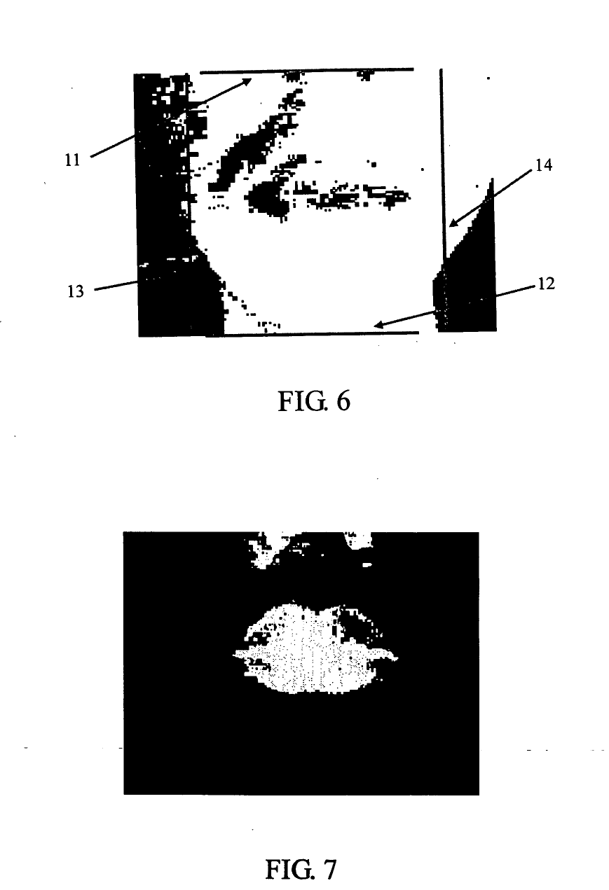

To efficiently detect the lip zone, the present invention pre-treats the face through YCbCr color space conversion and dividing the face into pixels. After YCbCr conversion, an image with Cb ranging 77 and 130, and Cr ranging 130 and 173 is generated as shown in FIG. 6. The divided face can further define a top boundary 11, a bottom boundary 12, a left boundary 13 and a right boundary 14. Since the WebCam captures an image under the nose, the left boundary 13 and the right boundary 14 are moved inward about one eighth as critical boundaries of the lip zone. Within the boundaries 11, 12, 13 and 14, the lip zone can be further searched.

### 2. Distinguishing Colors of the Lip (S42)

In the present invention, to automatically precisely detect the lip and conveniently acquire information of the lip for assessment, R and G of the RGB color system are used to distinguish a contour of the red lip, and the HSV color system is used to divide the lip zone. In general, lips are almost red regardless of wearing lip sticks.

### (1) Dividing with the RGB Color System

Referring to FIG. 7, lips are generally red and therefore can be determined according to relationship of red (R) and green (R) of the RGB color system as the following formulae:

$$\begin{matrix}{L}_{lim} \leq \frac{R}{G} \leq {U}_{lim} & ( a ) \\ if \{ \begin{matrix}1 ← {L}_{lim} \leq \frac{R}{G} \leq {U}_{lim} \\ 0 ← otherwise\end{matrix} & ( b )\end{matrix}$$

wherein R is red and G is green of the RGB color system, 4 μm is a lower threshold, Uₗᵢₘ is an upper threshold, if R/G ranges between the thresholds, the pixel will be 1, otherwise 0, so that a binary image is completed to detect the lip zone, and a center, length and width of the lip zone can be determined. In some preferred embodiments, lip zones can be detected with R/G ranging 1.1˜2.8.

### (2) Dividing with HSV Color Space

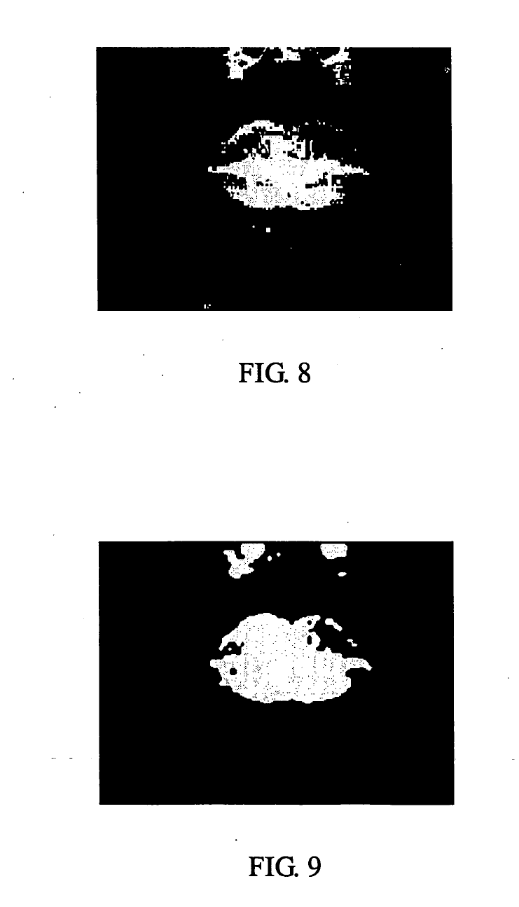

In the HSV color system, H, S and V respectively means hue, saturation and value, and eight colors are quantified, i.e., red, yellow, green, cyanic, blue, magenta, white and black. The hue ranges [0, 359], and saturation and value range [0.0, 1.0]. The HSV color system may clearly divide different colors. Therefore, the lip image is first converted into HSV, wherein H is larger than 300 or less than 60, S ranges [0.16, 0.85], and V ranges [0.21, 0.85]. Each pixels (P) is checked whether fall within the above ranges, if yes, this pixel is 1, otherwise 0. FIG. 8 shows a result of the HSV conversion.

The above two color systems may result in different lip zone, wherein the RGB color system is easily affected by light. Therefore, the present invention combines both color system to promote precision in finding the lip zone.

### 3. Eliminating Spots (S43)

As the captured lip image could be limited by light and WebCam, the binary image perhaps includes lots of spots and undesired pixels having HSV within the above ranges. The present invention therefore applies “morphology operation” and “median filter” to eliminating the undesired pixels.
(1) morphology operation: The binary image can form different features through this analysis which includes some operators, for example, erosion, dilation, open and close. After morphology operation, most undesired spots and fine blanks on the lip image divided with the RGB color system can be respectively removed and filled by “open” and “close”, so that the lip contour will be clearer.
(2) median filter: After open and close of morphology operation, the rest of spots can be eliminated through a 3×3 median filter. If a half or more of the pixels (P) in the 3×3 matrix are white, then all of nine pixels (P) will be changed as white. Thus scattering spots can be eliminated and error rate for extracting the lip zone will be reduced. FIG. 9 shows a result image in which spots are eliminated by open and close of morphology operation, and median filter.

### 4. Determining the Lip Zone (S44)

After dividing the lip zone and eliminating spots, the lip contour may present. To clearly assessing pronunciation by comparing a series of lip images, the images captured with the WebCam are restricted around the lip.

“Connected Component Analysis” is a method for identifying a component of an image and its connected neighbors, in which different pixels are given different numbers. To apply “Connected Component Analysis” to the present invention, each pixel (P) are numbered.

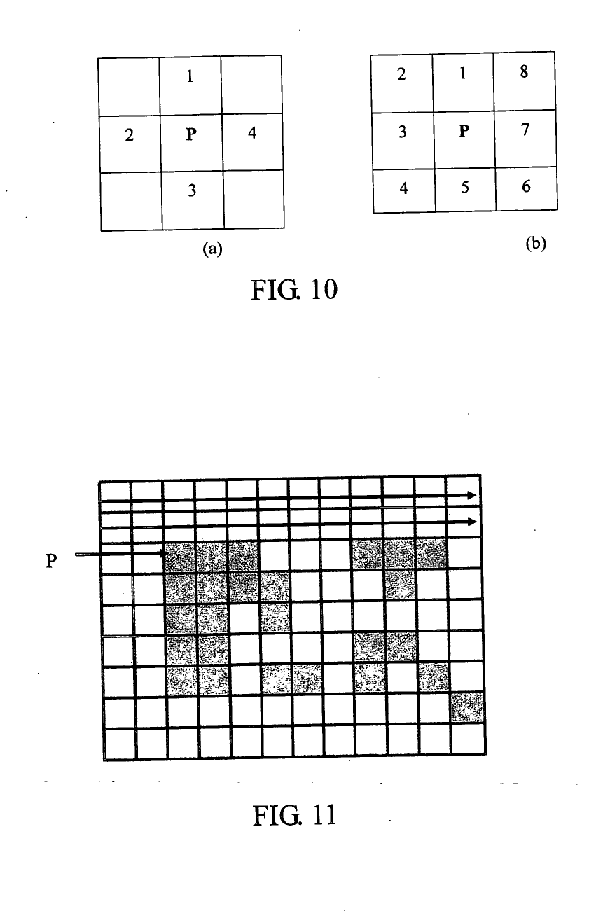

In an image, each pixel (P) has four or eight neighboring pixels. As shown in FIG. 10, the pixel (P) in (a) has four neighboring pixels 1˜4, and the pixel (P) in (b) has eight neighboring pixels 1˜8.

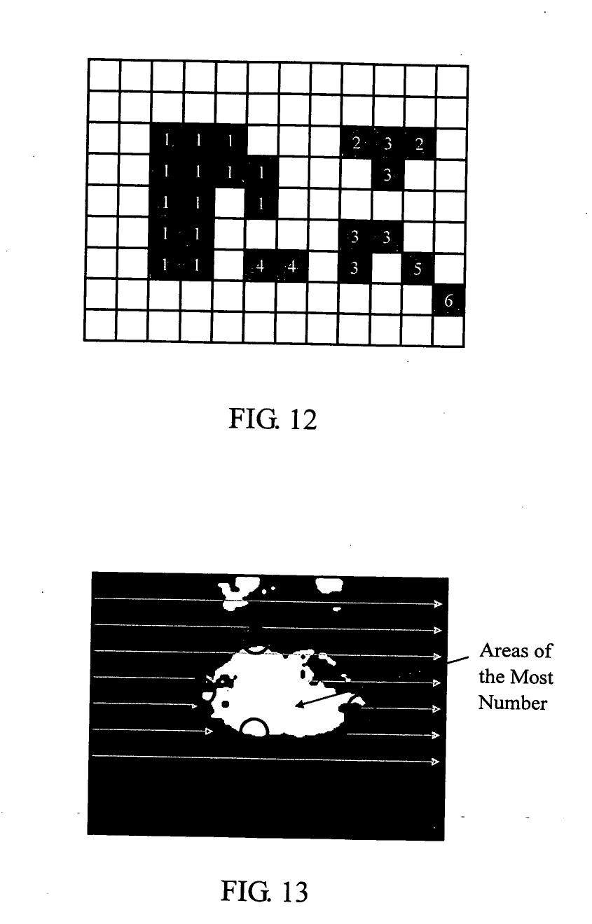

In a preferred embodiment, four neighboring pixels are adapted, that is, all neighboring pixels of the pixel (P) are in the same area. As shown in FIG. 11, pixels of the binary image after median filter are checked one by one from the left top to the right bottom. The pixel (P) is searched in an order of top, left, bottom and right. When a pixel and around neighboring pixels thereof are numbered, next pixel (P) will be searched. If the next pixel has been numbered, it will be skipped. After all pixels (P) are searched, all pixels are numbered. FIG. 12 shows the numbered image of FIG. 11.

After numbering each pixel with “connected component analysis”, the lip zone will include pixels having the most number since the red lip is divided through the RGB color system. The way to search the lip begins from the left top pixel, and the first searched pixel (P) having a number as the same as the most number will be recorded as a top boundary of the lip contour, and then a bottom boundary of the lip contour can be searched in the same manner. As the top and bottom boundaries are found, left and right boundaries will be found, too. A searching process is indicated as follows:

For i = 0 to a height of the image
For j = 0 to a width of the image
If pixels(i,j) = the most number, Then
top = i < top ? i : top
bottom = i > bottom ? i : bottom
left = j < left ? j : left
right = j > right ? j : right
End If
Next j
Next i

wherein top, bottom, left and right are respectively the top boundary 11, the bottom boundary 12, the left boundary 13 and the right boundary 14 of the lip contour. FIG. 13 illustrates the searching process.

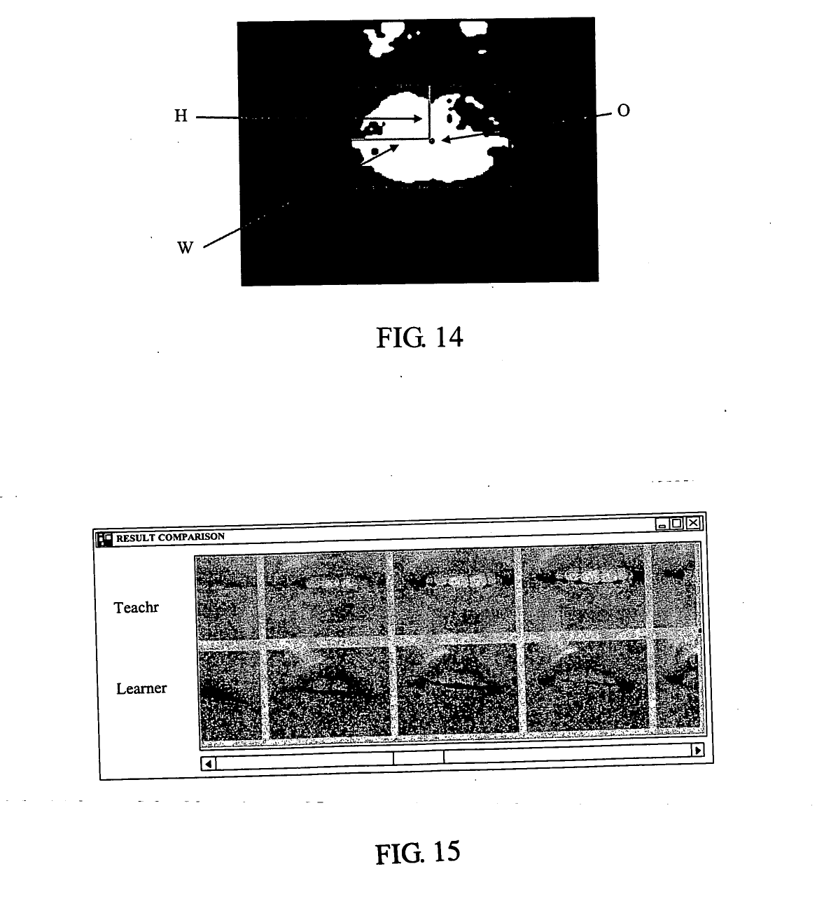

While the top, bottom, left and right boundaries 11˜14 of the lip contour are determined, a center (O), a width (W) and a height (H) of the lip contour will be determined as shown in FIG. 14, which are also the basic information of the lip.

(e) Assessment Mode (S5)

In the present invention, the assessment mode includes a visual assessment of lip images and a combinative assessment of images and voices.

### 1. Visual Assessment of Lip Images

In the present invention, “Dynamic time warping (DTW)” and “Pattern Matching” are applied to comparing the teacher's lip images and the learner's. In such processes, useless images are deleted after estimation and meaningful images are remained for assessment. The more similar between the learner's images and the teacher's, the higher score is acquired by the learner.

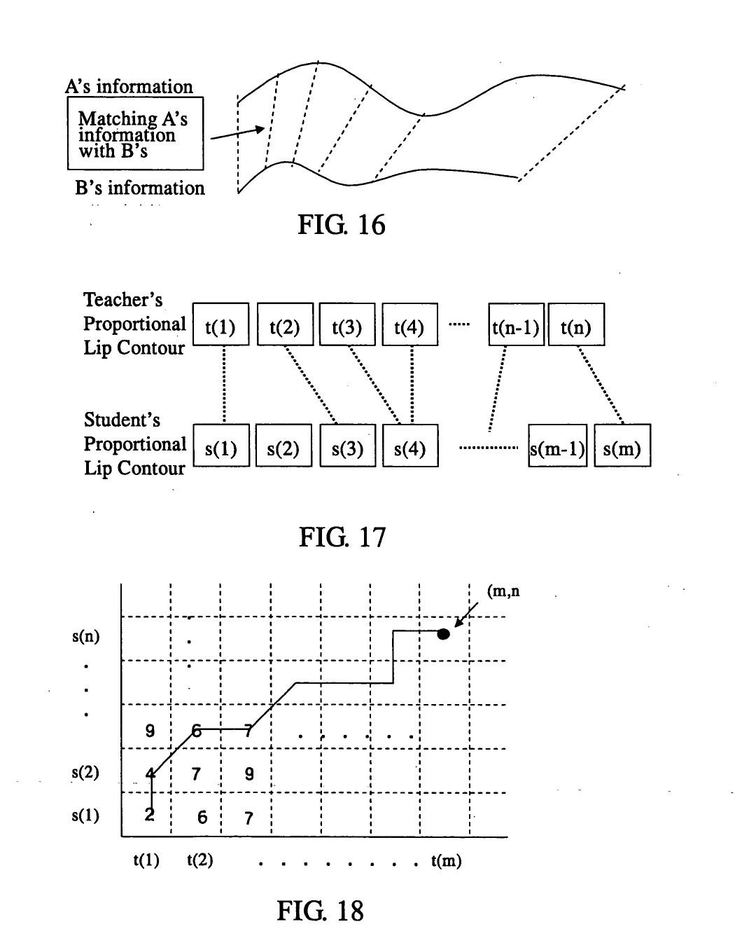

“Dynamic time warping (DTW)” is a general method for speech recognition. Though the teacher's and the learner's take different time to speak a word or a sentence, DTW decreases deviation of nonlinear relationship between them as possible, as shown in FIG. 15. In FIG. 16, “Dynamic time warping (DTW)” matches A's information with B's, though A and B take different time to speak the same sentence. As a result, A's images can more exactly correspond with B's images, as shown in FIG. 17.

FIG. 18 shows that the teacher has m lip images, t(1), t(2), . . . , t(m), and the learner has n lip images, s(1), s(2), . . . , s(n). By means of “dynamic time warping (DTW)”, an optimal path from (1,1) to (m,n) will be found on an m×n plane. If d(i,j) is the distance form t(i) to s(j), i.e., d(i,j)=|t(i)−s(j)|, then the optimal path will be the short accumulative distance D(i,j) from (1,1) to (m,n). that is,

$$d ( 1 , 1 ) = \vert t ( {1}^{->} ) - s ( {1}^{->} ) \vert , \\ and$$

$$\vert t ( {1}^{->} ) - s ( {1}^{->} ) \vert = {\sum }_{i = 1}^{q} {\sum }_{j = 1}^{p} \vert {t}_{1} ( i , j ) - {s}_{1} ( i , j ) \vert , \\ \text{wherein:}$$

$$\begin{matrix}t ( {1}^{->} ) = < t ( 1 , 1 ) , t ( 1 , 2 ) , … , t ( 1 , p ) , t ( 2 , 1 ) , … , t ( 2 , p ) , … , t ( q , p ) & ( 1 ) \\ r ( {1}^{->} ) = < r ( 1 , 1 ) , r ( 1 , 2 ) , … , r ( 1 , p ) , r ( 2 , 1 ) , … , r ( 2 , p ) , … , r ( q , p ) & ( 2 ) \\ figure size of t ( 1 ) = figure size of r ( 1 ) == p \times q & ( 3 )\end{matrix}$$

The initial point d(1,1) is first calculated, and D(1,1)=0+2×d(1,1), then the accumulative distances D(1,2), D(1,3) . . . are sequentially determined according to the following formula:

$$D ( i , j ) = min \{ \begin{matrix}D ( i , j - 1 ) + d ( i , j ) \\ D ( i - 1 , j - 1 ) + 2 d ( i , j ) \\ D ( i - 1 , j ) + d ( i , j )\end{matrix} \qquad ( 4 )$$

When the accumulative distance is found, the shortest accumulative distance can be determined by returning to the last step, i.e., the optimal path. If the optimal path is: c(1), c(2), . . . c(p), c(k)=(t(k), s(k)), 1≦k≦p, then procedures for finding the path include:

$$for$$

$$m = k - 1 to 1$$

$$i = c ( m + 1 )$$

$$j = d ( m + 1 ) \\ [ c ( m ) , d ( m ) ] = \partial min \{ \begin{matrix}D ( i , j ) \\ D ( i - 1 , j - 1 ) \\ D ( i - 1 , j )\end{matrix} \\ next$$

wherein m is returning times, c(m) is a position of i in the mth step, d(m) is a position of j in the mth step. Therefore, in each returning procedure, the minimum of D(i,j−1), D(i−1,j−1) and D(i−1,j) will be selected as the path. In order to accelerate DTW computation, additional assumptions are used:
I. Boundary condition:

c(1)=(1,1), c(p)=(m,n)

t(k−1)≦t(k) (5)

II. Increasing condition:

s(k−1)≦s(k)

t(k)−t(k−1)≦1 (6)

III. Continuity condition:

s(k)−s(k−1)≦1 (7)

IV. Window constraint:

|t(k)−s(k)|≦w, w is window size (8)

V. Slope constraint: moving at least y steps in s-direction after moving x steps in t-direction.

FIG. 16 shows the teacher's and learner's continuous images processed with “dynamic time warping (DTW)” which also deletes similar images to facilitate sequent comparison of contours and assessment.

It's advantageous to utilize proportional contours in assessment, for example, calculation of the contour is much less than that of the whole image, and thus errors will be reduced. In addition, normalization will be no more necessary when using the proportional contours. Therefore, the proportional contours are used in the preferred embodiment.

The images processed with “spatial-temporal” are RGB full color (24 bits), wherein R, G and B range from 0 to 255. Differences between the teacher's contour and the learner's are summated as formulae (9) and (10).

$$\begin{matrix}Rate = W / H & ( 9 ) \\ E = \frac{{\sum }_{i = 0}^{b} ( {T}_{i} - {S}_{i} )}{K} & ( 10 )\end{matrix}$$

Rate is a ratio of width to height of the teacher's or the learner's images, Tᵢ is a proportional contour of the teacher's ith image, S1 is a proportional contour of the learner's ith image, K is an amount of the total images, E is an average of the differences of the contours. The way to convert differences into scores ranging for 0 to 100 is as follows:

$$\begin{matrix}Max E = max ( E i ) , i = 1 , … , n & ( 11 ) \\ Score = 100 - 100 \times \frac{E}{Max E} & ( 12 )\end{matrix}$$

wherein MaxE is the maximum among the differences, and score is a result of 100 minus 100×(E/MaxE).

### 2. Combinative Assessment of Images and Voices

External noise is always a problem for speech recognition. To correctly assess one's pronunciation, the lip contours and comparison with standard speech will be used for assessment.

In the present invention, speech recognition and the assessment mod are used together with visual assessment of lip images, and the results show that combinative assessment of voices and images is more precise than only one of voices and images.

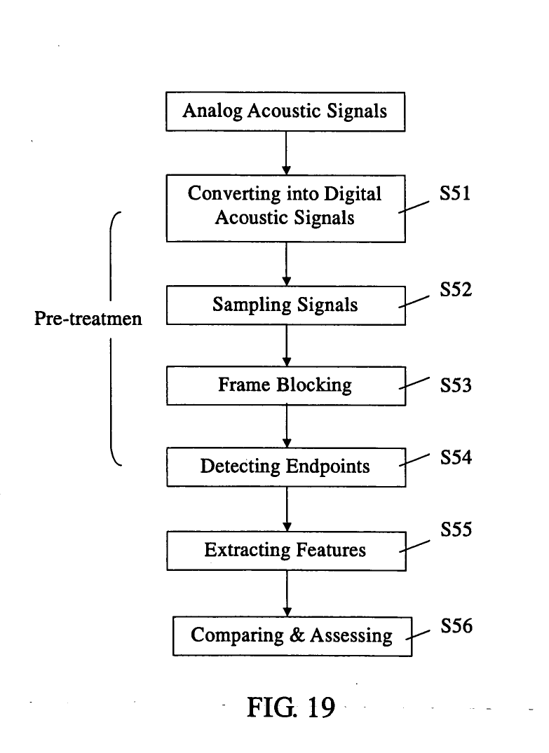

For processing audio signals, an input device is utilized to convert analog audio signals into digital signals from which features of the speech are then extracted. FIG. 19 shows such a process.

### (1) Converting into Digital Signals

Natural human speeches are in the form of analog signals, which have to be converted into digital signals through the inputting device (S51). The digital signals are then processed through sampling (S52) in a rate of 16 KHz, and frame blocking (S53) with a frame size of 512 points (about 32 ms) and overlapping 170 points (about one third of a frame).

### (2) Detecting Endpoints (S54)

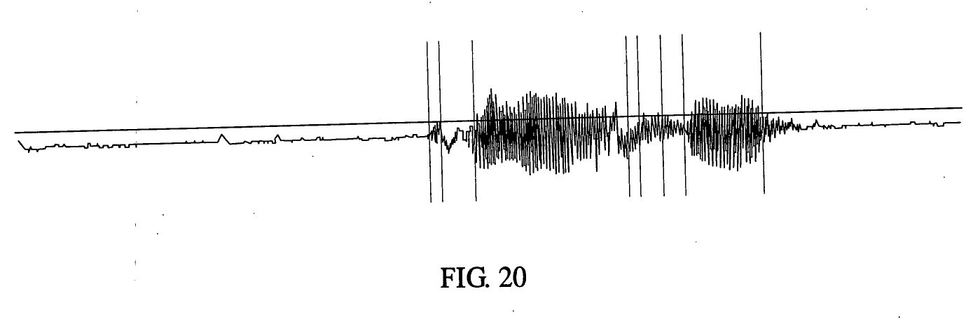

In general, a speech includes one or more silence durations which are mostly unnecessary as shown in FIG. 20. To efficiently acquire speech information, endpoints are detected to delete the silence nearby. In the present invention, “short-term energy” and “zero crossing rate” are utilized to determine the silence by setting a threshold.

### I. Short-Term Energy

In one speech, sonic energy may vary with time, wherein the silence is relatively lower than others. Therefore, a threshold is properly set to distinguish silence or not, whereby the desired frames can be identified. An average energy of the frames in a short duration is calculated according to formula (13):

$${E}_{k} = \frac{1}{N} {\sum }_{n = m}^{N + m + 1} \vert S ( n ) \vert \qquad ( 13 )$$

wherein Eₖ is the average energy of the kth frame, N is sampling number in a frame, S(n) is the nth point in the kth frame, and m is an initial point of the frame.

### II. Zero Crossing Rate

“Zero crossing rate” means times that the audio signals cross zero point, and is expressed as follows:

$$\begin{matrix}{Z}_{k} = \frac{1}{2} {\sum }_{n = 1}^{N - 1} \vert sgn ( s ( n ) ) - sgn ( s ( n - 1 ) ) \vert & ( 14 ) \\ sgn ( s ( n ) ) = \{ \begin{matrix}+ 1 , if s ( n ) \geq 0 \\ - 1 , if s ( n ) < 0\end{matrix} & ( 15 )\end{matrix}$$

wherein Zₖ is the kth zero crossing rate, sgn(s(n)) is 1 if s(n) is larger than 1, otherwise −1. In general, noise has a zero crossing rate larger than breathy sound, and much larger than normal sound. Therefore, the breathy sound can be detected and judged by the zero crossing rate and a preset threshold. By means of energy detection and zero crossing rate, voiceless consonants and voiced vowels can be distinguished.

### (3) Extracting Features (S55)

Features of speeches may vary with gender, age, area, psychological or physical states. Therefore, it's very complex to directly compare audio signals, and the result will be limited. To overcome this problem, features of sound are pre-treated in the form of feature vector, i.e., feature extraction. In a preferred embodiment, “linear prediction coding (LPC)” and “cepstrum coefficient” are applied to feature extraction.

### I. Linear Prediction Coding (LPC)

As an important and efficient method for speech analysis, “linear prediction coding” assumes that a speech sample can be predicted from a linear combination of previous p samples. To decrease deviation between the real sample and the predicted speech, formula (16) is applied:

$$S ( n ) = {\sum }_{k = 1}^{P} {a}_{k} \cdot S ( n - k ) + G \cdot U ( n ) \qquad ( 16 )$$

wherein U(n) is an input of an time-variant digital filter, G is a control parameter of amplitude gain, p is number of previous sample, and aₖ is an LPC coefficient.

### II. Cepstrum Coefficient

“Spectrum coefficient” is a distribution of average energy of the speech on frequency band; and can be transformed into “cepstrum coefficient”. Though the spectrum coefficient is more similar to information heard by the human, the cepstrum coefficient facilitates speech recognition and thus widely used.

### (4) Pattern Matching Assessment (S56)

“Pattern matching” is a method for assessing speech by comparing the sample and the standard phoneme by phoneme, and then a score is obtained according to the results. For “pattern matching”, volume strength curve, pitch contour, Mel-frequency cepstral coefficients are used to adjust parameters. Then the minimum average deviation of dynamic time warping (DTW) is calculated, and the score will increase with similarity between the assessed speech and the standard speech.

In addition, an acoustic model used for speech recognition can be derived from “hidden Markov model (HMM)”. The hidden Markov model (HMM) basically includes dual random processes, one of which is hidden and invisible from the acoustic signal sequence, for example, variation of the throat, tongue and inside the mouth. Another random process is an observation sequence which indicates a probability distribution of all features with “state observation probability”. Therefore, HMM is particularly suitable for describing the features, since each state can be a vocal tract in a certain articulatory configuration and “state observation probability” predicts the probabilities of voices performed with a certain articulatory configuration.

To sum up, the present invention exhibits merits as follows:
1. By automatically assessing the learner's lip during pronouncing and thus rectifying the learner's lip position, the present invention can be an effective assessment model for English language.
2. By interactive practicing or e-learning through a system of the present invention, the learner can distinguish incorrect and correct pronunciation and thus rectify it.
3. The present invention may provide an interactive mode to stimulate the learner's interest.
4. For the deaf people unable to learn English by listening, the present invention provides sequential images to help them practicing and rectifying incorrect pronunciation.
5. The present invention utilizes proper techniques to compare the lip contours and thus promotes accuracy of assessment.

What is claimed is:

1. A method for assessing a learner's pronunciation through voices and images, comprising steps of:
(1) adding a new word or sentence by a teacher via an interface, capturing the teacher's lip with a WebCam, and storing lip images and corresponding acoustic signals in a database;
(2) selecting and speaking a word or a sentence from the database by the learner;
(3) capturing the learner's lip images with a WebCam;
(4) automatically finding a lip zone by distinguishing colors of the learner's face with color space conversion and then dividing the face into several pixels, eliminating spots, computing the image with an algorithm, and defining a range of the learner's face so as to searching a boundary of the lip;
(5) assessing the learner's pronunciation by comparing the captured lip images and voices with those built in the database.

2. The method of claim 1, wherein the color space conversion for defining the learner's face in the step (4) is a YCbCr system.

3. The method of claim 1, wherein the colors on the learner's face are distinguished to determine top, bottom, right and left boundaries, and then the right and left boundaries are moved inward about one eighth respectively as critical lines of the lip zone.

4. The method of claim 3, wherein the learner's lip is divided with a RGB color system, in which a ratio R/G is limited as follows:
$${L}_{lim} \leq \frac{R}{G} \leq {U}_{lim} , \\ if \{ \begin{matrix}1 ← {L}_{lim} \leq \frac{R}{G} \leq {U}_{lim} \\ 0 ← otherwise\end{matrix} ;$$
wherein Lₗᵢₘ and Uₗᵢₘ are a lower threshold and an upper threshold of R/G for converting pixels into 1 (R/G ranging between Lₗᵢₘ and Uₜᵢₘ) or 0 (R/G ranging beyond Lₗᵢₘ and Uₜᵢₘ), whereby a binary image is formed; pixels of the binary image is then numbered with “connected component analysis”, wherein the pixels of the most numbers is determined as the lip zone, and then undesired spots on the binary image are eliminated with morphology operation and median filter.

5. The method of claim 3, wherein the learner's lip is divided with a HSV color system, in which thresholds of H (hue), S (saturation) and V (value) are preset for converting pixels into 1 (within the thresholds) or 0 (beyond the thresholds) and thus forming a binary image; pixels of the binary image is then numbered with “connected component analysis”, wherein the pixels of the most numbers is determined as the lip zone, and then undesired spots on the binary image are eliminated with morphology operation and median filter.

6. The method of claim 3, wherein the learner's lip is divided with a RGB color system and a HSV color system, wherein:
in the RGB system, a ratio R/G is limited as follows:
$${L}_{lim} \leq \frac{R}{G} \leq {U}_{lim} , \\ if \{ \begin{matrix}1 ← {L}_{lim} \leq \frac{R}{G} \leq {U}_{lim} \\ 0 ← otherwise\end{matrix} ;$$
wherein Lₗᵢₘ and Uₗᵢₘ are a lower threshold and an upper threshold of R/G for converting pixels into 1 (R/G ranging between Lₗᵢₘ and Uₗᵢₘ) or 0 (R/G ranging beyond Lₗᵢₘ and Uₗᵢₘ); and
in the HSV color system, thresholds of H (hue), S (saturation) and V (value) are preset for converting pixels into 1 (within the thresholds) or 0 (beyond the thresholds) and thus forming a binary image; pixels of the binary image is then numbered with “connected component analysis”, wherein the pixels of the most numbers is determined as the lip zone, and then undesired spots on the binary image are eliminated with morphology operation and median filter.

7. The method of claim 7, 10 or 13, wherein the binary image is processed with morphology operation and median filter to eliminate undesired spots.

8. The method of claim 1, wherein the step (4) utilizes “connected component analysis” for computation to distinguish a pixel and its neighboring pixels, and particularly give different numbers to pixels of different features.

9. The method of claim 1, wherein the step (5) utilizes “dynamic time warping (DTW)” and “pattern matching” to compare a teacher's and a learner's lip images by deleting useless images and remaining useful image for assessment.

10. The method of claim 1, wherein the step (5) utilizes proportional contours for assessment, in which differences of assessed images and standard images are summarized:
$$\begin{matrix}Rate = W / H \\ E = \frac{{\sum }_{i = 0}^{b} ( {T}_{i} - {S}_{i} )}{K}\end{matrix}$$
wherein Rate is a ratio of width to length of the assessed images and the standard images, Tᵢ is a proportional contour of the teacher's ith image, Sᵢ is a proportional contour of the learner's ith image, K is an amount of the total images, E is an average of the differences of the contours; and the way to convert differences into scores ranging for 0 to 100 is as follows:
$$\begin{matrix}Max E = max ( E i ) , i = 1 , … , n \\ Score = 100 - 100 \times \frac{E}{Max E}\end{matrix}$$
wherein MaxE is the maximum among the differences, and score is a result of 100 minus 100×(E/MaxE).

11. The method of claim 1, wherein the step (5) is to process acoustic signals by converting analog acoustic signals into digital signals through an input device, and then extracting features of the signals for assessment.

12. The method of claim 11, wherein the step (5) for processing acoustic signals includes sub-steps of:
(1) sampling analog signals—converting the analog signals into digital signals;
(2) detecting endpoints—deleting silence on two ends;
(3) extracting features—combining proper features into feature vectors as basises of assessment;
(4) pattern matching assessment—comparing assessed speech and standard speech phoneme by phoneme to find their difference for assessment.

13. The method of claim 12, wherein the feature is extracted with linear prediction coding (LPC) and cepstrum coefficient.

14. The method of claim 12, wherein the endpoints are detected with short-term energy and zero crossing rate, and the silence is judged with a threshold.

15. The method of claim 12, wherein pattern matching uses volume strength curve, pitch contour, Mel-frequency cepstral coefficients to adjust parameters, and then a minimum average deviation of dynamic time warping (DTW) is calculated for assessment.

16. The method of claim 12, further comprising speech recognition by utilizing an acoustic model derived from hidden Markov model (HMM) which includes a hidden random process and an observation sequence for describing a probability distribution of all features with “state observation probability”.
